(19) United States
(12) Patent Application Publication
(10) Pub. No.: US 2012/0050292 A1
(43) Pub. Date: Mar. 1, 2012

(54) METHOD AND APPARATUS FOR THE REPRESENTATION OF RELATIONSHIPS BETWEEN ELEMENTS

(76) Inventor: FRANK EDUGHOM EKPAR, AIZUWAKAMATSU CITY (JP)

(21) Appl. No.: 12/868,832

(22) Filed: Aug. 26, 2010

(51) Int. Cl. G06T 11/20

(52) U.S. Cl. 345/440

(57) ABSTRACT

The present invention discloses methods, systems and devices for indicating relationships between elements in a system using suitable representations of the relationships, suitable representations of the elements and suitable representations of associations between the representations of the relationships and the representations of the elements in the system. In one embodiment, the principles of the present invention are applied to the representation of associations between resources in a computer system. Furthermore, the complex relationships between elements in a virtual tour system are simplified on the basis of the principles of the present invention in another embodiment.

### REFERENCE TO RELATED PRIOR APPLICATION

This non-provisional application claims the benefit of the earlier filed provisional patent application entitled “METHOD AND APPARATUS FOR THE REPRESENTATION OF RELATIONSHIPS BETWEEN ELEMENTS” and mailed (Express Mail Label Number: EF 437533295 JP) from Koriyama City, Japan on Aug. 27, 2009 around 15:00 PM Japan Time as well as the benefit of the earlier filed provisional patent application No. 61/243,859 entitled “ENHANCED METHOD AND APPARATUS FOR THE REPRESENTATION OF RELATIONSHIPS BETWEEN ELEMENTS” filed on Sep. 18, 2009 which are hereby incorporated by reference in their entirety.

### BACKGROUND OF THE INVENTION

1. Field of the Invention

The present invention relates generally to the fields of information processing, information visualization and allied fields. In particular, the invention relates to methods, systems and devices for indicating relationships between elements in a system using suitable representations of the relationships, suitable representations of the elements and suitable representations of associations between the representations of the relationships and the representations of the elements in the system.

2. Description of the Prior Art

Modern computer systems—including operating systems and software applications—contain graphical representations of resources such as files, network locations, folders and devices. In these systems, resources are generally represented as icons. For certain classes of resources such as files and folders, standard data structures such as trees are used to indicate the relationships between the resources. Clicking or double-clicking an icon representing a resource is usually associated with an action such as the opening of that resource for viewing or further processing or access to additional information associated with the resource. Thus, these contemporary systems use well-defined and generally limited data structures to represent the associations between resources and simple symbols such as icons to represent the resources themselves. However, it is desirable in many situations to utilize more flexible and possibly dynamic—changing with respect to time, events or other stimuli—representations of resources and to allow the creation of more powerful associations between resources. For example, it would be useful to assign a meaningful operation to the drawing of a line between two icons on the desktop of a modern operating system. Such an operation could be used to link the information represented by the icons in a useful way.

### SUMMARY OF THE INVENTION

It is an object of the present invention to provide methods, systems and devices for indicating relationships between elements (such as resources in a computer) in a system using suitable representations of the relationships, suitable representations of the elements and suitable representations of associations between the representations of the relationships and the representations of the elements in the system. One of the benefits of the principles of the present invention is the simplification of the representation of the relationships between elements in a system leading to easier comprehension of the information in the system and more straightforward application of the information in the accomplishment of useful tasks. The principles of the present invention permit simple and intuitive representations of complex relationships in systems with arbitrary types of elements, relationships and associations. Another object of the present invention is to provide a system for creating and representing dynamic—changing with respect to time, events or other stimuli—associations between elements.

### BRIEF DESCRIPTION OF THE DRAWINGS

FIG. 1 illustrates the preferred embodiment of the information representation system of the present invention.

FIG. 2 shows an additional embodiment for practicing the principles disclosed in the present invention.

### DETAILED DESCRIPTION OF THE PREFERRED EMBODIMENTS

U.S. Pat. No. 7,567,274 issued to the present inventor and describing methods, systems and devices for the creation and management of interactive virtual tours describes elements and resources that could be contained in a control engine and used to indicate the relationships between views in a viewing engine and the states of elements in the control engine. The '274 patent also introduced bi-directional communication between the control and viewing engines and/or other parts of the virtual tour system that could be used to facilitate the indication of the relationships. Preview elements disposed in multidimensional space/time could also be used to represent elements (environment maps) and their attributes according to the principles of the '274 patent. The present invention improves on the relationship representation systems, methods and devices described in the '274 patent by introducing general-purpose methods, systems and devices for indicating relationships between elements (such as resources in a computer) using suitable representations of the relationships, suitable representations of the elements and suitable representations of associations between the representations of the relationships and the representations of the elements in the system.

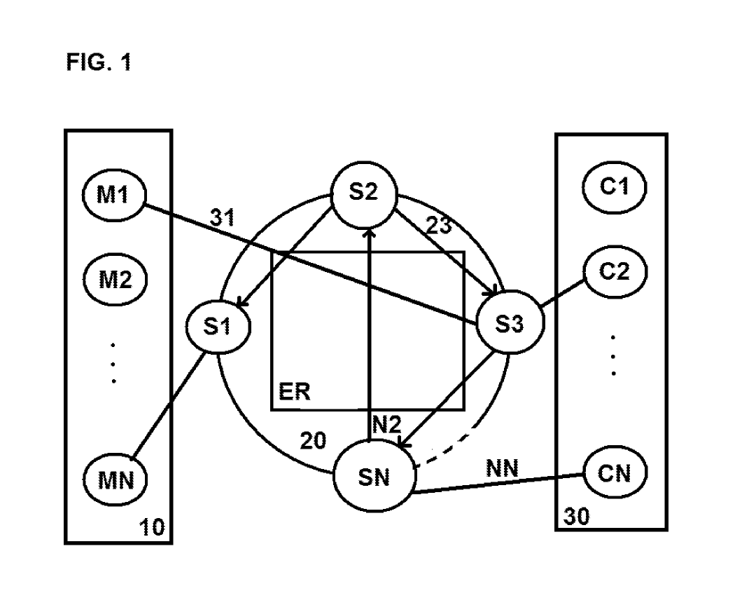

FIG. 1 depicts the preferred embodiment of the present invention and indicates map or multimedia elements labeled M1, M2, . . . , MN and contained within the two-dimensional grid 10; scene (environment map) elements labeled S1, S2, . . . , SN rendered as nodes on the two-dimensional loop 20; compass (view direction indicator) elements labeled C1, C2, . . . , CN contained within the two-dimensional grid 30; lines 23, 31, N2 and NN representing associations between scene, map or multimedia and compass elements and extra representation element, ER indicating extra or additional information for the representation of one or more elements. The system shown in FIG. 1 could represent part of a virtual tour system or part of any other system that could be represented in the manner indicated.

Maps could be added to the system via suitable means such as the opening of image files representing the maps or in the form of the representation of a global positioning system (GPS)-enabled map rendering that could be rendered once or updated periodically or dynamically and/or in real time. Other suitable means of adding maps could be used. The term map as used in this context could refer to a graphical representation of the salient features of a location of interest. The representation could be in dimensions (for example in 2- or 3-dimensions) suitable for the specific system under consideration.

Multimedia elements—for example video, audio, images, slide shows, animations, general-purpose graphics, text, commands and/or suitable combinations of these and/or other elements—could be added via a suitable multimedia authoring subsystem or any other suitable means.

Scene elements could represent environment maps such as those described in U.S. Pat. No. 7,567,274. Other suitable representations could also be used.

The extra representation could be in the form of additional information about a scene element or any other part of the system. For example, this could be in the form of an expanded view of the scene showing greater detail. The extra representation could also be in the form of methods, systems or devices permitting the execution of a query or search that yields additional information about a specific scene or any other desired part of the system.

Compass elements could be added to the system by opening image files that could be used as direction indicators or via the use of any suitable system or element for view direction or status indication.

Note that although each type of element (map or multimedia element, scene element and compass element) depicted in FIG. 1 appears in a separate group or category, elements of different types could be mixed and matched where appropriate. Additionally, elements of any type could be used.

The N in M1, M2, . . . , MN; S1, S2, . . . , SN; C1, C2, . . . , CN, N2 and NN could be 0 (indicating the absence of the element or association indicated), 1, 2, 3 or any suitable number.

Although as illustrated in FIG. 1, the map or multimedia elements are depicted as thumbnails contained within a two-dimensional grid, the scene elements as nodes in a two-dimensional loop and the compass elements as thumbnails contained within a two-dimensional grid, each category or group of elements could be represented in N-dimensional space and/or time where N is 1, 2, 3, 4 or any other suitable number. Furthermore, elements could be arranged in any configuration with any suitable shape or surface.

Any element of any suitable type can be added to the system using any suitable representation.

One or more suitable representations of each element could be used. For example, a representation depicting a navigable view of a scene element could be implemented as a thumbnail and used in isolation or in combination with one or more representations depicting meaningful events related to the scene element such as the activation, deactivation and/or rendering time of the scene.

Lines 23, 31, N2 and NN in FIG. 1 denote associations between elements. For instance, line 23 could indicate a link between the scene elements labeled S2 (source scene) and S3 (target scene) that could be implemented as a hotspot with an active region that can be clicked to evoke a desired action such as a transition or jump from scene S2 to scene S3. Similarly, line N2 could represent a link between scene SN (source scene) and scene S2 (target scene). Further, line 31 could represent a synchronization relationship—similar to those described in U.S. Pat. No. 7,567,274—between the scene labeled S3 and the map or multimedia element labeled M1. In the same vein, line NN could represent a synchronization relationship between the scene labeled SN and the compass or view direction indicator element labeled CN.

It should be understood that any suitable associations between any elements or groups of elements could be defined. Some associations—such as those represented by lines 23 and N2 in FIG. 1—comprise arrows indicating the general flow of the association (for example, 23: link from scene S2 to scene S3; N2: link from scene SN to scene S2) while other associations—such as those represented by lines 31 and N2 in FIG. 1—comprise of a simple line. Other suitable representations of associations such as 1-, 2- or 3-dimensional representations and/or time varying associations and dynamic associations dependent on other stimuli such as events defined within the system could also be utilized.

Associations between elements can be created visually. One example of the visual creation of associations in the case of a virtual tour system comprising scenes represented as nodes—S1, S2, . . . , SN—on a loop, maps or floor plans or multimedia elements represented as thumbnails—M1, M2, . . . , MN—and compasses represented as thumbnails—C1, C2, . . . , CN—as depicted in FIG. 1, is a method or apparatus permitting an operator to draw a line from the representation of one element (for example, a line from the node representing a specific scene of interest) to the representation of the associated element (for example, the thumbnail representing a map, multimedia element, compass or a scene within the virtual tour) to represent the desired association between the source element and the target element.

In the case where the source element is a scene and the target element is another scene, the line symbolizing the association could represent a scene hotspot defined as an active N-dimensional region (where N could be 1, 2, 3, 4 or any other suitable dimension) that when activated (for example, via a mouse click in a graphics- or based computer system) causes actions equivalent to a transition or jump from the source scene to the target scene to be carried out.

Further, in the case where the source element is a scene and the target element is a representation of a resource such as a website on the Internet [possibly encoded as a Uniform Resource Locator (URL) or in any other suitable representation], the line symbolizing the association could represent a URL hotspot defined as an active N-dimensional region (where N could be 1, 2, 3, 4 or any other suitable dimension) that when activated (for example, via a mouse click in a graphics- or based computer system) causes the associated website or resource to be presented, accessed or processed in any desired manner

The active N-dimensional region of the hotspot mentioned in the foregoing discussion could be implemented as a time-sensitive 2- or 3-dimensional space or other suitable representation. In this context, time-sensitivity could be implemented as an association between the rendering or presentation time of the source scene and the rendering or presentation time of the hotspot. More specifically, for video-based scenes, the hotspot could be programmed to start presenting at a specific time or frame within the scene video and to stop presenting at a specific time or frame within the scene video.

Visual and/or other suitable representations of elements and/or their associations and/or relationships could be employed (for instance, by clicking or double-clicking on the representation) to specify and/or edit the attributes of the underlying elements, associations and/or relationships.

The principles of the present invention permit the creation and/or management of associations between elements in ways other than the visual examples described herein. Automatic and/or event-driven and/or dynamic association generation and management could be employed according to the principles of the present invention. Furthermore, associations could be updated dynamically as the number of elements in the system and the relationships between them change or in response to other suitably defined conditions.

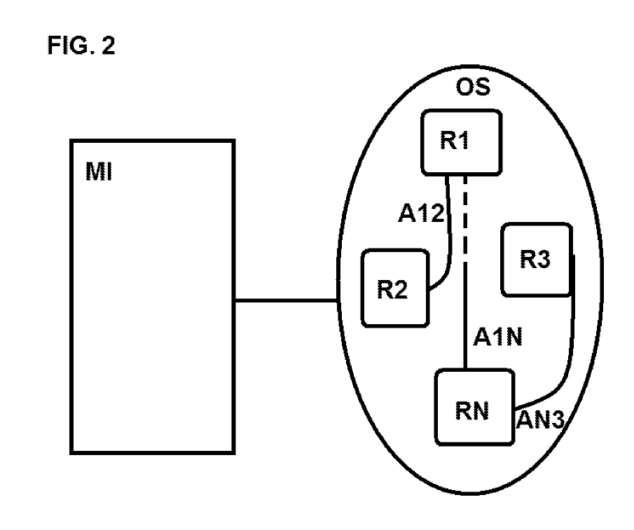

Referring now to FIG. 2, an additional embodiment illustrating how the principles of the present invention could be practiced, a computer system labeled OS (operating system) contains, possibly in addition to other elements, resources depicted as R1, R2, R3, . . . , RN. The computer system, OS, could represent a view of an operating system such as the desktop while the resources could be represented as icons associated with files, folders, cameras, networks and other devices, or more generally, any resources managed by the system. As illustrated in FIG. 2, the computer system, OS, could be connected operatively to a mediating interface, indicated as MI. The mediating interface could be used to facilitate the creation and/or management of associations between the elements of the system. Standard computer interface systems based on the mouse, keyboard and/or related systems could be used to implement the mediating interface, MI. Furthermore, brain-computer or neuronal interfaces such as those described in U.S. provisional patent application No. 61/137,891 filed on Aug. 5, 2008 could also be used. Other suitable interfaces such as gesture based interfaces could be used where appropriate. It should be noted that the mediating interface need not be present in all cases but only when required. A set of associations or relationships between elements in the system are indicated by the connections labeled A12 (link or association between resource R1 and resource R2), MN (link or association between resource R1 and resource RN) and AN3 (link or association between resource RN and resource R3) are shown in FIG. 2 and as explained in the foregoing description of the preferred embodiment, could represent suitably defined relationships between the elements or resources. By way of a specific example, an icon representing a camera in a computer operating system could be linked to another icon representing a folder containing picture files retrieved from the camera by drawing a line or otherwise defining a similar geometrical entity or a gesture in a gesture-based interface system that could be interpreted as defining a link between the two resources to establish a “synchronization” relationship between the resources such that pictures acquired using the camera are automatically uploaded as picture files to the connected folder—thus synchronizing the two linked or connected resources. Any aspect of the system (for instance, the generation of the link or connection and/or the management of same) could be mediated or facilitated by the mediating interface, MI, of FIG. 2.

The methods and systems disclosed in the present invention could be used to link or connect multimedia and other resources and to facilitate interaction between and/or with the resources so linked or connected. Accordingly, the approach described herein could be named iMedia Connect (iMedia Connection), iMedia Link (iMedia Linking), etc.

Although the foregoing disclosure described specific methods, techniques and systems that could be used to carry out the present invention, it should be understood that the present invention is not limited to the foregoing description. Further, it should be understood that numerous alternative embodiments and equivalents of the invention described herein may be employed in practicing the invention and that such alternative embodiments and equivalents fall within the scope of the present invention.

What is claimed is:

1. A method for indicating relationships between elements in a system using suitable representations of the relationships, suitable representations of the elements and suitable representations of associations between the representations of the relationships and the representations of the elements in the system.

2. A system implementing means for indicating relationships between elements in a system using suitable representations of the relationships, suitable representations of the elements and suitable representations of associations between the representations of the relationships and the representations of the elements in the system.
